(19) United States
(12) Patent Application Publication
(10) Pub. No.: US 2004/0213010 A1
(43) Pub. Date: Oct. 28, 2004

(54) Bi-functional headlamp having a linear shifting sleeve with integral actuator

(75) Inventors: Paul D. Van Duyn, Anderson, IN (US); Tony E. Collins, Alexandria, IN (US); James M. Mills, Pendleton, IN (US)

Correspondence Address: RUSSELL E. FOWLER, II, ICE MILLER, ONE AMERICAN SQUARE, BOX 82001, INDIANAPOLIS, IN, 46282-0002, US

(73) Assignee: Guide Corporation, Pendleton, IN (US)

(21) Appl. No.: 10/420,610

(22) Filed: Apr. 22, 2003

(51) Int. Cl. F21V 17/02; F21V 1/10

(52) U.S. Cl. 362/512; 362/280; 362/324; 362/361

(57) ABSTRACT

An automotive headlamp assembly comprises a reflector positioned within a housing. The reflector defines a lamp cavity where a light source is positioned. The reflector includes a first portion designed to reflect light in a low beam pattern and a second portion designed to reflect light in a high beam pattern. An actuator is also positioned within the lamp cavity. The actuator is operable to move a light shield in a linear direction parallel to the optical axis of the reflector. In particular, the actuator is operable to move the light shield between a low beam position that exposes the light source to the first portion of the reflector and a high beam position that exposes the light source to both the first portion and the second portion of the reflector.

### BACKGROUND

This invention relates to the field of automotive headlamps, and particularly to moveable bulb shields in automotive headlamp assemblies.

Automobiles require both low beam and high beam headlamps. To provide low beam and high beam headlamps, automobile manufacturers often provide two separate headlamp assemblies on each side of an automobile or two separate reflectors in a single headlamp assembly (i.e., multiple cavity headlamp assemblies). In these situations, one reflector provides a low beam headlamp and the other reflector provides a high beam headlamp.

Unfortunately, the use of two reflectors to provide low beam and high beam headlamps results in numerous disadvantages. First, two reflectors use up valuable space in the automobile. If less space were used, the automobile could be made smaller, or additional styling features could be provided in the additional space. Second, the need for two separate reflectors and/or lamp assemblies adds to the overall cost of the vehicle. This is realized in increased parts cost and in increased labor costs for installation of two lamp assemblies or assembly of multiple-cavity lamp assemblies. Third, a momentary switching effect is noticed in automobiles having one low beam lamp assembly or reflector and a separate high beam lamp assembly or reflector. In particular, when the headlights are switched from low beam to high beam (or vice-versa) a brief dark period or brief double light period can be noticed. This switching effect is generally undesirable for the driver as well as any traffic on the road. Fourth, in cold and wet weather conditions, the lamp assembly that is not being used is susceptible to icing. In particular, the light source heats the lamp assembly that is in use and prevents the accumulation of ice or snow. However, when the user switches from low beam to high beam, the high beam may have a distorted beam pattern from the accumulation of ice or be entirely blocked by the accumulation of snow. In addition to the above, because the color of the light beam is dependent upon the type of headlamp and light source (e.g., reflector, projector, HID, projector, etc.), slight variations in beam color often result when different types of headlamps and light sources are used to provide high beam and low beam lights. Accordingly, it would be advantageous to provide a single reflector/lamp assembly that is capable providing both low beam and high beam headlights using a single reflector and a single bulb. It would also be advantageous if such lamp assembly could be easily implemented with relatively few moving parts.

### SUMMARY

An automotive headlamp assembly comprises a reflector positioned within a housing. The reflector defines a lamp cavity where a light source is positioned. The reflector includes a first portion designed to reflect light in a low beam pattern and a second portion designed to reflect light in a high beam pattern. A frame is also positioned within the lamp cavity. An actuator is seated on the frame and is connected to a shield support. A cylindrical light shield partially covers the light source at one end and is connected to the shield support at the other end. The actuator is operable to move the light shield in a linear direction parallel to the optical axis of the reflector. In particular, the actuator is operable to move the light shield between a low beam position that exposes the light source to the first portion of the reflector and a high beam position that exposes the light source to both the first portion and the second portion of the reflector.

### BRIEF DESCRIPTION OF THE DRAWINGS

FIG. 1 shows a cross-sectional view of one embodiment of an automotive headlamp having a bi-functional bulb shield assembly with integral shifting sleeve where the bulb shield is in a low beam position;

FIG. 2 shows a cross-sectional view of the automotive headlamp assembly of FIG. 1 where the bulb shield is in a high beam position; and

FIG. 3 shows a front view of the automotive headlamp assembly of FIG. 1.

### DESCRIPTION

An bi-functional bulb shield assembly with integral shifting sleeve for an automotive headlamp 10 comprises a bulb sleeve or other shield 12 partially surrounding or covering a light bulb 14 or other light source. The bulb shield 12 is connected to an actuator 20 used to alter the position of a bulb shield in such a way as to create projected light patterns for high beam and low beam output.

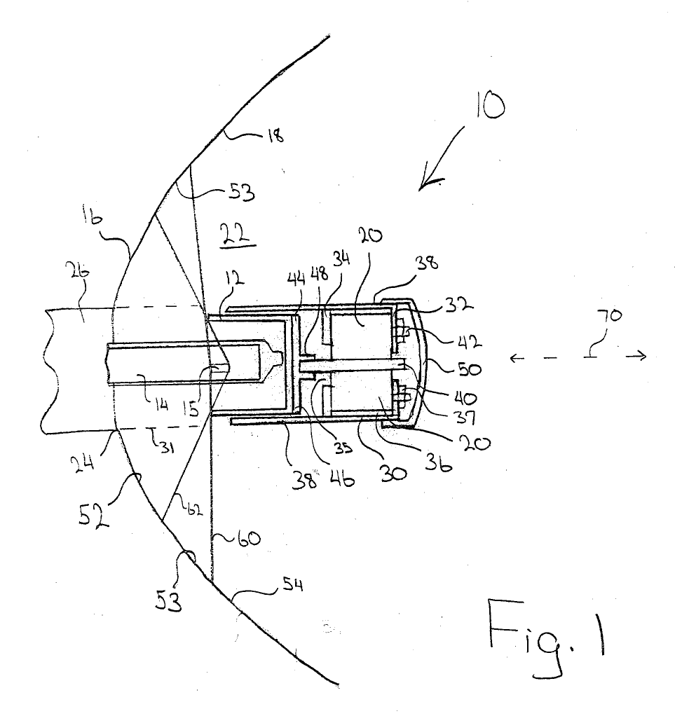

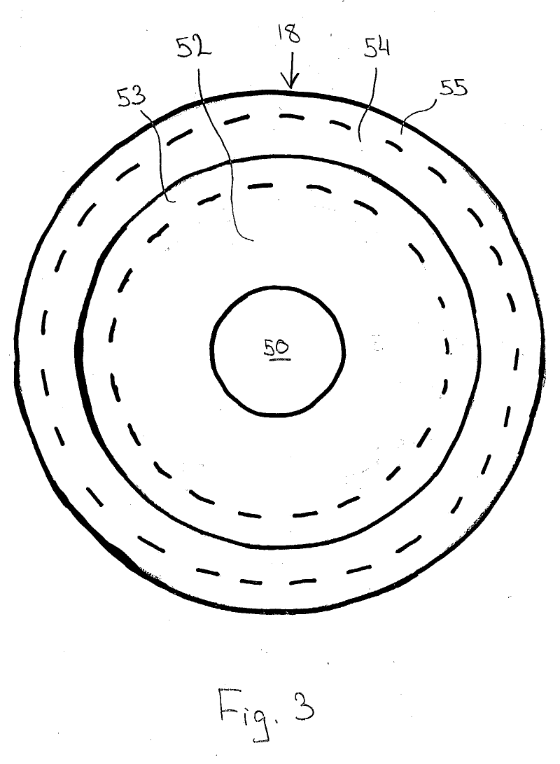

As shown in FIG. 1, the automotive headlamp includes a reflector 18 positioned within the housing 16 of the automotive headlamp. The reflector 18 is generally parabolic in cross-sectional shape, and forms a circular outline when viewed from the front (see FIG. 3). Of course, numerous reflectors of different shapes and sizes may also be used. The surface of the reflector reflects light that strikes the surface. The reflector 18 is shaped such that a first portion 52 of the reflector reflects light from the light bulb in a low beam headlight, and a second portion 54 of the reflector is used to reflect light from the light bulb in a high beam headlight. The low beam portion 52 of the reflector is adjacent to and concentric with the high beam portion 54.

The low beam portion 52 of the reflector 18 includes a transition portion 53 that defines the outer cut-off area for the low-beam portion. The transition portion 53 is the area of the low-beam portion 52 of the reflector 18 that encounters decreasing amounts of filament exposure. In particular, the amount of filament to which the transitional portion 53 is exposed diminishes from full filament exposure at the inner periphery of the transition portion to no exposure at the outer periphery of the transition portion (in the low beam mode). The ray traces in FIG. 1 show the transition portion between ray trace 60 and ray trace 62. The inner periphery of the transition portion 53 is represented by dotted lines in FIG. 3.

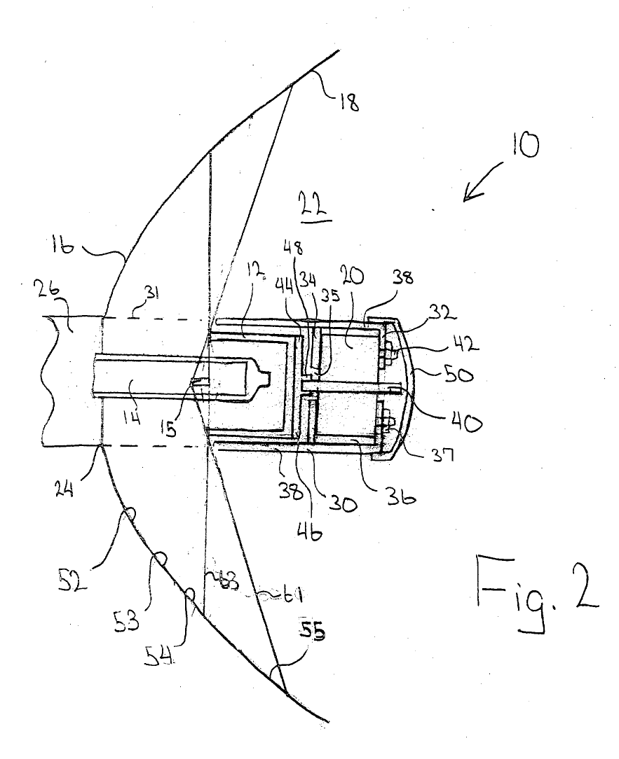

Similarly, the high beam portion 54 of the reflector 18 includes a diminishing portion 55. The diminishing portion 55 is the area of the high-beam portion 54 of the reflector that is encounters decreasing amounts of filament exposure. In particular, the amount of filament to which the diminishing portion 55 is exposed diminishes from full filament exposure at the inner periphery of the diminishing portion to no exposure at the outer periphery of the diminishing portion (in the high beam mode). The ray traces in FIG. 2 show the diminishing portion 55 between ray trace 61 and ray trace 63. The inner periphery of the diminishing portion 55 is represented by dotted lines in FIG. 3.

The light bulb 14 includes a filament 15 (or other light emitting portion). The light bulb is seated in a socket 26 that connects to a bulb opening 24 formed in the housing. The socket 26 connects the light bulb 14 to the automobile electrical system. When the socket 26 is connected to the housing 16, the bulb 14 extends through the reflector 18 and into a lamp cavity 22 defined by the reflector and any covering on the reflector (e.g., a transparent front cover or lens). In some applications, the lamp cavity may be scaled from the outside environment and/or contained within a controlled atmosphere.

A frame 30 is also positioned within the lamp cavity 22. The frame 30 is made of a rigid, relatively light material. The frame 30 includes opposing walls 38 that partially define an actuator slot/seat 36. Two flanges 32 extend from the ends of the opposing walls 38 to further define the actuator seat 36. In addition, an actuator support in the form of a circular disc 34 with a center hole 35 is joined to the opposing walls of the frame to further define the actuator seat.

The actuator is attached to the circular disc 34 and the circular disc serves as a thermal between the bulb 14 and the actuator. Frame legs (not shown) extend from the opposing walls and attach the frame to the reflector surface or the housing. For example, the frame legs may extend parallel from the opposing walls along dotted lines 31 and join the frame to the reflector near the opening 24 in the housing 16.

The actuator 20 is located within the lamp cavity and is positioned in an actuator slot 36 of the frame 30. The actuator may be joined to the frame using adhesives or any other fastening means such as nuts 37 and bolts/threaded studs 42. The actuator is also attached to the circular disc 34 such that the circular disc may be used to properly position the actuator in the actuator slot 36. In one embodiment, the actuator is a solenoid having an actuator shaft 40 or piston that is concentric with the center hole 35 of the circular disc 34 and extends from the actuator parallel to the opposing walls 38 of the frame 30. Actuator wiring (not shown) is secured to the frame and runs adjacent to the frame structure. The actuator wiring provides a path for electric current from the vehicle's primary electrical system to the actuator. When electric current is delivered to the actuator, the actuator shaft 40 moves in a linear direction further into the actuator (i.e., is retracted). When electric current is removed from the actuator, the actuator shaft 40 moves in a linear direction further out of the actuator (i.e., is extended). A spring (not shown) is provided to encourage the actuator shaft toward the extended position when the actuator is not energized. The spring may be provided inside the actuator or between the shield support 44 and disc 34. A decorative cap 50 is positioned over the frame such that the actuator is shielded from view when the headlamp is viewed from the front.

A shield support 44 engages the end of the actuator shaft 40. The shield support includes a circular plate 46 having a boss 48 extending from in the middle of the circular plate 46. The boss 48 receives the end of the actuator shaft 40 and is thereby connected to the actuator shaft. The shield support serves to thermally insulate actuator 20 from the heat provided by the light source.

The bulb shield 12 is attached to shield support 44. The bulb shield is generally cylindrical in form. The base of the bulb shield 12 is closed and connected to the shield support 44. The top of the bulb shield 12 is open and receives a portion of the light bulb 14, such that the light bulb extends into the cylinder of the bulb shield along the center axis of the bulb shield. Accordingly, the bulb shield partially covers the light source, as the bulb shield blocks light from the light source from striking certain portions of the reflector. The bulb shield 12 is made of a heat resistive material such that the heat generated from the light bulb 14 will not damage the bulb shield. Because the bulb shield 12 is attached to the shield support 44 and actuator shaft 40, movement of the actuator shaft also results in movement of the bulb shield. The bulb shield 12 is integral with the actuator 20, as the bulb shield 12 is fixedly connected to the shield support 44 and the shield support 44 is fixedly connected to the actuator shaft 40.

In operation, when the actuator is not energized, the actuator shaft 40 and bulb shield 12 are in an extended position with a portion of the light bulb encircling the bulb shield. This extended position is represented in FIG. 1. With the bulb shield in this position, light emitted from the light source strikes the first portion 52 of the reflector that is centrally located near the bulb opening 24 in the housing. As discussed previously, diminishing amounts of light also strike the transition portion 53 of the first portion 52 of the reflector 18. Light reflected from the first portion 52 of the reflector is directed out the front of the headlamp assembly 10 and forms a low-beam. However, because the bulb shield surrounds a significant portion of the light bulb when the bulb shield is in the extended position, light emitted from the light bulb/filament is blocked from striking a second portion 54 of the reflector that is closer to the periphery of the reflector. Placement of the shield in the extended position may also referred to herein as a “low beam position” because placement of the shield in this position results in a low beam being emitted from the headlamp.

Energization of the actuator causes the actuator shaft and bulb shield to move in a linear direction parallel to the optical axis 70 of the reflector. In particular, energization of the actuator causes the actuator shaft and bulb shield to move from the extended position shown in FIG. 1 into the retracted position shown in FIG. 2. With the bulb shield in this retracted position, the bulb shield surrounds less of the light bulb, and light emitted from the light source strikes both the first portion 52 of the reflector as well as the second portion of the reflector 54. Light reflected from the second portion of the reflector is directed out the front of the headlamp assembly 10 along with light from the first portion of the reflector to form a high-beam. Placement of the shield in the retracted position may also referred to herein as a “high beam position” because placement of the shield in this position results in a high beam being emitted from the headlamp. Notwithstanding the foregoing, the term “high beam” as used herein is not limited to beams associated with traditional “high beam” headlamps, but is meant to encompass other types of light beams that may be used in automotive applications, such as “motorway” lamps, fog lamps, etc.

When shifting between the high beam position and the low beam position, a smooth transition from high beam to low beam occurs without the need for sudden switching. In particular, the light beam appears to grow from low beam to high beam, without the need for one lamp being turned on and another lamp turned off. Later, when the operator of the vehicle decides to return to the low beam headlamp, the actuator is de-energized and the spring returns the bulb shield to the extended or “low beam” position. Again, a smooth transition occurs between the high beam and the low beam.

As discussed previously, FIG. 3 is a front view of the reflector showing the portions of the reflector that reflect light from the light source. In particular, the first portion 52 of the reflector, including the transition portion 53, reflects light from the light source when the bulb shield is in the extended position (i.e., low beam position). The second portion of the reflector 54, including diminishing portion 55, reflects light from the light source when the bulb shield is in the retracted position (i.e., the high beam position). Together, light reflected off the first and second portions of the reflector when the bulb is in the retracted position provide the high beam headlight, with the low beam headlamp enhanced to include a high beam because additional portions of the reflector are exposed to the filament.

In an alternative embodiment of the invention, the bulb shield is continuously adjustable between the extended position which shields the light source 14 to produce the “high beam” and the retracted position which shields the light source to produce the “low beam”. To this end, the actuator is capable of incrementally moving the bulb shield between the extended and the retracted positions, thereby providing a beam of light with a continuously variable diameter (e.g., a circular beam of light such as that represented in FIG. 3 where the diameter of the light beam may be adjusted any where on the second portion of the reflector). In one embodiment, the headlamp could be designed to repetitively move between the high beam and low beam positions, thereby providing a pulsing effect with the headlamp.

Although the present invention has been described in considerable detail with reference to certain preferred versions thereof, other versions are possible. For example the invention could be used in association with an automotive tail lamp or other type of lamp, and its use is not limited to headlamps. As another example, the actuator described above could be a stepper motor that cooperates with the shield support to move the shield support in or out. In particular, the shield support could be threadedly engaged with the actuator shaft to encourage movement of the shield support in the linear direction. Therefore, although the described embodiments of the invention have included a light bulb, alternative embodiments of the invention could include other light sources, such as light emitting diodes. Therefore, the spirit and scope of the appended claims should not be limited to the description of the preferred versions contained herein.

What is claimed is:

1. A headlamp assembly comprising:
a. a reflector defining a lamp cavity;
b. a light source positioned within the lamp cavity;
c. a shield partially covering the light source; and
d. an actuator positioned within the lamp cavity, the actuator operable to move the shield between a low beam position and a high beam position.

2. The headlamp assembly of claim 1 wherein the actuator is a solenoid.

3. The headlamp assembly of claim 1 wherein the actuator is an electric motor.

4. The headlamp assembly of claim 1 wherein the actuator is operable to move the shield in a linear direction along the optical axis of the reflector.

5. The headlamp assembly of claim 1 wherein the reflector includes a first portion and a second portion, wherein placement of the shield in the low beam position exposes the light source to the first portion of the reflector and placement of the shield in the high beam position exposes the light source to both the first portion and the second portion of the reflector.

6. The headlamp assembly of claim 1 further comprising a frame positioned within the lamp cavity, wherein the actuator is positioned upon the frame.

7. The headlamp assembly of claim 1 further comprising a shield support, wherein the shield is attached to the shield support and the shield support engages the actuator.

8. A headlamp assembly comprising:
a. a reflector defining a lamp cavity;
b. a light source positioned within the lamp cavity;
c. a shield positioned within the lamp cavity and partially covering the light source;
d. an actuator integrally connected to the shield, the actuator operable to move the shield between an extended position and a retracted position.

9. The headlamp assembly of claim 8 wherein the actuator is a solenoid.

10. The headlamp assembly of claim 8 wherein the actuator is an electric motor.

11. The headlamp assembly of claim 8 wherein the actuator is operable to move the shield in a linear direction along the optical axis of the reflector.

12. The headlamp assembly of claim 8 wherein the reflector includes a first portion and a second portion, wherein placement of the shield in the extended position exposes the light source to the first portion of the reflector and placement of the shield in the retracted position exposes the light source to both the first portion and the second portion of the reflector.

13. The headlamp assembly of claim 8 further comprising a frame positioned within the lamp cavity, wherein the actuator is positioned upon the frame.

14. The headlamp assembly of claim 8 further comprising a shield support, wherein the shield is attached to the shield support and the shield support engages the actuator.

15. A method of providing low beam and high beam headlamps for an automotive vehicle, the method comprising:
a. providing a reflector having an optical axis and defining a lamp cavity;
b. providing a light source positioned within the lamp cavity;
c. providing a shield partially covering the light source; and
d. moving the shield in a linear direction parallel to the optical axis between a low beam position and a high beam position.

16. The method of claim 15 wherein an actuator positioned within the lamp cavity is used to move the shield between a low beam position and a high beam position.

17. The method of claim 16 wherein the actuator is integrally connected to the shield.

18. A headlamp assembly comprising:
a. a reflector having a first portion and a second portion, the first portion designed to reflect light in a low beam pattern and the second portion designed to reflect light in a high beam pattern;
b. a light source positioned to emit light on first portion and the second portion of the reflector;
c. a moveable shield for blocking light from the light source; and
d. means for moving the shield in a linear direction between a low beam position and a high beam position such that movement of the shield to the low beam position blocks light from striking the second portion of the reflector and movement of the shield to the high beam position allows light to strike the second portion of the reflector.
